(19) United States
(12) Patent Application Publication
(10) Pub. No.: US 2008/0203913 A1
(43) Pub. Date: Aug. 28, 2008

(54) Plasma Display Panel (PDP)

(76) Inventors: Jung-Suk Song, Suwon-si (KR); Dong-Hyun Kim, Suwon-si (KR); Jeong-Min Choi, Suwon-si (KR); Jun-Tae Kim, Suwon-si (KR)

Correspondence Address: ROBERT E. BUSHNELL, 1522 K STREET NW, SUITE 300, WASHINGTON, DC, 20005-1202, US

(21) Appl. No.: 11/905,131

(22) Filed: Sep. 27, 2007

(30) Foreign Application Priority Data
Feb. 23, 2007 (KR) 10-2007-0018496

(51) Int. Cl. H01J 17/49

(52) U.S. Cl. 313/582

(57) ABSTRACT

A Plasma Display Panel (PDP) includes: a panel assembly having a first substrate, and a second substrate coupled to the first substrate; a chassis base coupled to the panel assembly, and supporting the panel assembly; and a foam adhesive member interposed between the panel assembly and the chassis base, and dissipating heat produced from the panel assembly. Since the porous foam adhesive member is interposed between the panel assembly and the chassis base, heat dissipation efficiency can be improved and image retention on a screen can be minimized.

### CLAIM OF PRIORITY

This application makes reference to, incorporates the same herein, and claims all benefits accruing under 35 U.S.C.§119 from an application for PLASMA DISPLAY PANEL earlier filed in the Korean Intellectual Property Office on 23 Feb. 2007 and there duly assigned Serial No. 10-2007-0018496.

### BACKGROUND OF THE INVENTION

1. Field of the Invention

The present invention relates to a Plasma Display Panel (PDP), and more particularly, the present invention relates to a PDP including an adhesive member with improved heat dissipation efficiency.

2. Description of the Related Art

In general, Plasma Display Panels (PDPs) are flat panel displays that display desired numbers, characters, or graphics by injecting a discharge gas into a discharge space between a plurality of substrates and sealing the discharge space, supplying Direct Current (DC) or Alternating Current (AC) voltages to a plurality of discharge electrodes to produce a gas discharge, and exciting phosphor layers using ultraviolet rays generated by the gas discharge to emit visible light.

PDPs include a panel assembly having a first substrate and a second substrate, a chassis base coupled to a rear surface of the panel assembly, a driving circuit board coupled to a rear surface of the chassis base, a signal transmitting unit transmitting an electrical signal between electrode terminals of the panel assembly and circuits of the driving circuit board, and a case accommodating all of the above elements.

Such conventional PDPs configured as described above may be manufactured by fabricating the first substrate and the second substrate in advance, assembling the first substrate and the second substrate into the panel assembly, coupling the chassis base to the rear surface of the panel assembly, coupling the driving circuit board to the rear surface of the chassis base, respectively connecting both terminals of the signal transmitting unit to the electrode terminals of the panel assembly and the circuits of the driving circuit board, and mounting all of the above elements in the case.

The conventional PDPs further include an adhesive member interposed between the panel assembly and the chassis base to attach the chassis base to the panel assembly. The PDPs can improve heat dissipation efficiency according to the properties of the adhesive member. Image retention of the panel assembly needs to be avoided using the adhesive member having an excellent heat dissipation efficiency.

### SUMMARY OF THE INVENTION

The present invention provides a Plasma Display Panel (PDP) that can improve heat dissipation efficiency and minimize image retention on a screen by improving the structure of an adhesive member interposed between a panel assembly and a chassis base.

According to an aspect of the present invention, a Plasma Display Panel (PDP) is provided including: a panel assembly having a first substrate, and a second substrate coupled to the first substrate; a chassis base coupled to the panel assembly, and supporting the panel assembly; and a foam adhesive member interposed between the panel assembly and the chassis base, and dissipating heat produced by the panel assembly.

The foam adhesive member may be foam graphite.

A first surface of the foam adhesive member may be directly attached to a rear surface of the second substrate.

A second surface of the foam adhesive member may be directly attached to a front surface of the chassis base.

The foam adhesive member may be a flat sheet.

The foam adhesive member may have a plurality of grooves formed therein.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is an exploded perspective view of a Plasma Display Panel (PDP) according to an embodiment of the present invention;

FIG. 2 is a cross-sectional view taken along line I-I of FIG. 1 when the PDP is assembled; and

FIG. 3 is an enlarged perspective view of an adhesive member of the PDP of FIG. 1.

### DETAILED DESCRIPTION OF THE INVENTION

The present invention is described more fully below with reference to the accompanying drawings, in which exemplary embodiments of the present invention are shown.

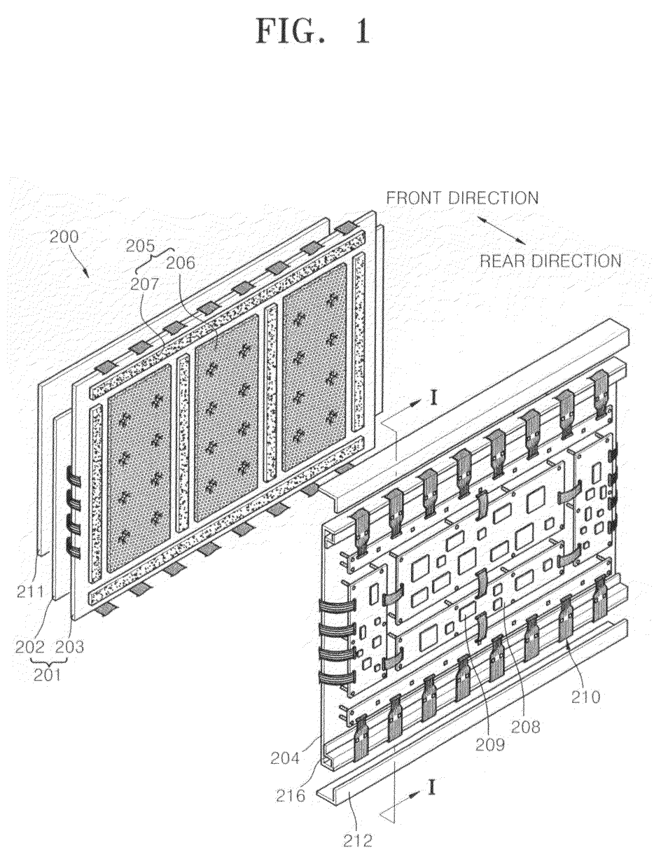

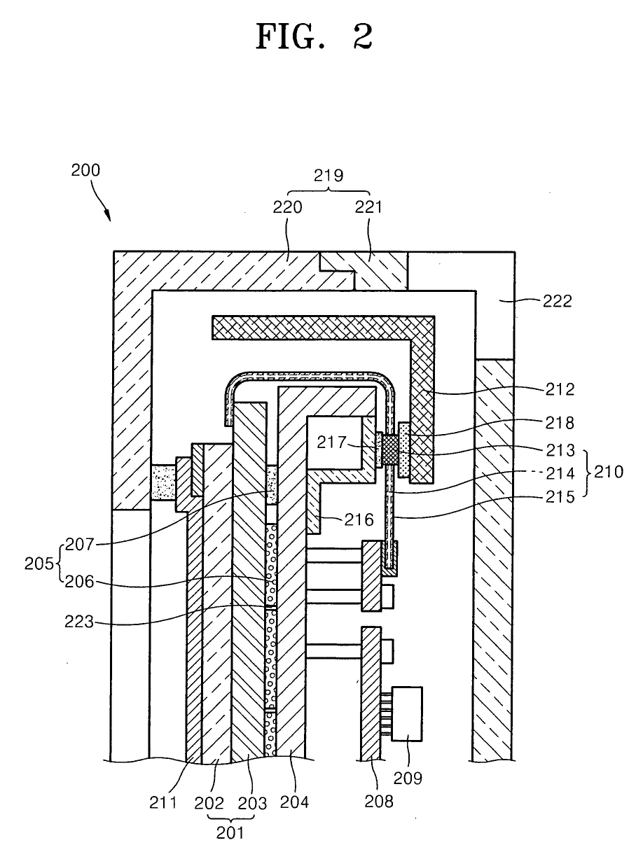

FIG. 1 is an exploded perspective view of a Plasma Display Panel (PDP) 200 according to an embodiment of the present invention. FIG. 2 is a cross-sectional view taken along line I-I of FIG. 1 when the PDP 200 is assembled.

Referring to FIGS. 1 and 2, the PDP 200 includes a panel assembly 201 having a first substrate 202, and a second substrate 203 coupled to the first substrate 202.

A chassis base 204 is attached to a rear surface of the panel assembly 201 using adhesive members 205. Chassis reinforcing members 216 are attached to upper and lower ends of a rear surface of the chassis base 204, and cover plates 212 are installed behind the upper and lower ends of the rear surface of the chassis base 204. A driving circuit board 208 is mounted behind the chassis base 204. A plurality of circuits 209 are mounted on the driving circuit board 208.

Signal transmitting units 210 are installed behind the upper and lower ends of the chassis base 204. First terminals of each of the signal transmitting units 210 are connected to respective electrode terminals of the panel assembly 201, and second terminals of each of the signal transmitting units 210 are electrically connected to the respective circuits 209 of the driving circuit board 208, such that each signal transmitting unit 210 can transmit an electrical signal between the panel assembly 201 and the driving circuit board 208.

Each signal transmitting unit 210 includes a driving Integrated Circuit (IC) 213, leads 214 electrically connected to-the driving IC 213, and a flexible film 215 covering the leads 214.

Each signal transmitting unit 210 is interposed between the chassis base 204 and each of the cover plates 212. A thermal grease 217 is interposed between the driving IC 213 and each of the chassis reinforcing members 216. A silicon sheet 218 is interposed between the driving IC 213 and the cover plate 212.

Filters 211 are directly attached to a front surface of the panel assembly 201. Each of the filters 211 shields electromagnetic waves produced from the panel assembly 201, blocks neon emission, and prevents external light from being reflected.

To this end, the filter 211 is formed by stacking a plurality of films. The films constituting the filter 211 may include an Anti-Reflection (AR) film for preventing the reflection of external light which may lead to degradation in visibility, an electromagnetic wave shielding film for effectively shielding electromagnetic waves produced during the operation of the panel assembly 201, and a selective wavelength absorbing film for blocking the emission of neon with a wavelength of about 590 nanometers. In addition, the filter 211 may include various other functional films.

The panel assembly 201, the chassis base 204, the driving circuit board 208, and the signal transmitting units 210 are received in a case 219. The case 219 includes a front cabinet 220 installed in front of the panel assembly 201, and a back cover 221 installed behind the chassis base 204. A plurality of through-holes 222 are formed in upper and lower ends of the back cover 221.

The adhesive members 205 can rapidly dissipate heat produced from the panel assembly 201 during the operation of the panel assembly 201.

The operation of the adhesive members 205 is explained in more detail as follows.

The adhesive members 205 include a foam adhesive member 206 and a plurality of double-sided adhesive members 207. The foam adhesive member 206 is interposed between the second substrate 203 and the chassis base 204. The foam adhesive member 206 outwardly dissipates heat produced from the panel assembly 201.

A first surface of the foam adhesive member 206 is directly attached to the rear surface of the second substrate 203. A second surface of the foam adhesive member 206 is directly attached to a front surface of the chassis base 204.

Alternatively, the foam adhesive member 206 may be attached only to the rear surface of the second substrate 203, not being attached to the front surface of the chassis base 204, such that the chassis base 204 can be spaced a predetermined distance apart from the second substrate 203. In this case, an air gap in which external air can circulate is formed between the chassis base 204 and the foam adhesive member 206.

The foam adhesive member 206 maybe a single sheet that can cover the entire rear surface of the second substrate 203. However, it is easier to separately attach a plurality of foam adhesive members 206 over the entire rear surface of the second substrate 203.

In the present embodiment, three flat sheet-like foam adhesive members 206 are used. The three foam adhesive members 206 are attached at predetermined intervals over the entire rear surface of the second substrate 203.

The plurality of double-sided adhesive members 207 are attached to portions of the rear surface of the second substrate 203 where the foam adhesive members 206 are not disposed. The double-sided adhesive members 207 are attached to spaces between adjacent foam adhesive members 206 and to portions along edges of the three foam adhesive members 206. The double-sided adhesive members 207 increase the adhesive force between the chassis base 204 and the second substrate 203.

The foam adhesive members 206 may be made of a material with a high thermal conductivity, such as foam graphite (e-graf), a hybrid carbon material, to improve heat dissipation efficiency not only in horizontal and vertical directions of the panel assembly 201, but also in a direction toward the chassis base 204. Since foam graphite is porous and has a thermal conductivity greater than 240 W/mK, the foam graphite can outwardly dissipate heat received from the panel assembly 201 in a very efficient manner.

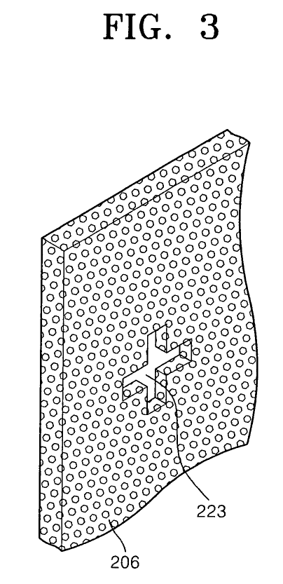

FIG. 3 is an enlarged perspective view of each of the adhesive members 206 of the PDP 200 of FIG. 1. Referring to FIG. 3, a plurality of grooves 223 are formed in each of the foam adhesive members 206. While the grooves 223 pass through the foam adhesive member 206 in a thickness direction of the foam adhesive member 206 in FIG. 3, the present embodiment is not limited thereto. The grooves 223 may have at least one shape selected from the group consisting of a cross shape, a straight-line shape, a circular shape, an oval shape, and a polygonal shape. Since the grooves 223 increase the surface area of the foam adhesive member 206, the temperature of the panel assembly 201 can be further reduced due to the grooves 223.

When external power is supplied to the PDP 200 constructed as described above, heat produced from the panel assembly 201 is dissipated through the foam adhesive members 206, and heat produced from the driving ICs 213 of the signal transmitting units 210 is dissipated through the chassis reinforcing members 216 and the cover plates 212.

Heat produced from the panel assembly 201 is rapidly cooled by natural convention of external air introduced through the through-holes 222 of the back cover 221.

When some of the heat transferred from the foam adhesive members 206 attached to the rear surface of the second substrate 203 is outwardly dissipated through the chassis base 204, heat dissipation efficiency can be considerably increased due to the grooves 223 formed in the foam adhesive members 206.

Table 1 shows panel assembly temperatures according to different adhesive members.

TABLE 1

| Comparative example | Embodiment |
|---|---|
| Adhesive member | Foam adhesive member |
| 55° C. | 49° C. |

In Table 1, the embodiment concerns a porous foam adhesive member attached to a rear surface of a panel assembly, and the comparative example concerns a conventional non-porous adhesive member attached to a rear surface of a panel assembly.

Referring to Table 1, the temperature of the panel assembly in the comparative example is 55° C. because of the non-porous adhesive member whereas the temperature of the panel assembly in the embodiment is 49° C. because of the porous foam adhesive member. It can be seen that the temperature of the panel assembly in the embodiment using the porous foam adhesive member is lower by 6° than the temperature of the panel assembly in the comparative example using the non-porous adhesive member.

As described above, since the PDP according to the present invention includes the porous foam adhesive member installed between the panel assembly and the chassis base, heat dissipation efficiency can be improved and image retention on a screen can be minimized. Material cost can be reduced, and thus module cost can be reduced.

While the present invention has been particularly shown and described with reference to exemplary embodiments thereof, it will be understood by those of ordinary skill in the art that various modifications in form and detail may be made therein without departing from the spirit and scope of the present invention as defined by the following claims.

What is claimed is:

1. A Plasma Display Panel (PDP) comprising:
a panel assembly including a first substrate, and a second substrate coupled to the first substrate;
a chassis base coupled to the panel assembly, and supporting the panel assembly; and
a foam adhesive member interposed between the panel assembly and the chassis base, and dissipating heat produced by the panel assembly.

2. The PDP of claim 1, wherein the foam adhesive member comprises a foam graphite.

3. The PDP of claim 2, wherein the foam graphite has a thermal conductivity greater than 240 W/mK.

4. The PDP of claim 1, wherein a first surface of the foam adhesive member is directly attached to a rear surface of the second substrate.

5. The PDP of claim 4, wherein a second surface of the foam adhesive member is directly attached to a front surface of the chassis base.

6. The PDP of claim 1, wherein a plurality of foam adhesive members are attached over an entire rear surface of the second substrate.

7. The PDP of claim 1, wherein a plurality of foam adhesive members are attached over a portion of a rear surface of the second substrate and wherein a plurality of double-sided adhesive members are attached to portions of the rear surface of the second substrate where the foam adhesive members are not disposed.

8. The PDP of claim 1, wherein the foam adhesive member comprises a flat sheet.

9. The PDP of claim 8, wherein the foam adhesive member has a plurality of grooves formed therein.

10. The PDP of claim 9, wherein the grooves pass through the foam adhesive member in a thickness direction of the foam adhesive member.

11. The PDP of claim 9, wherein the grooves have at least one shape selected from the group consisting of a cross shape, a straight-line shape, a circular shape, an oval shape, and a polygonal shape.
